(19) United States
(12) Patent Application Publication
(10) Pub. No.: US 2025/0228162 A1
(43) Pub. Date: Jul. 17, 2025

(54) Hay Transporting Trailer Assembly

(71) Applicants: Scott Dickinson, Goldendale, WA (US); Sarah Dickinson, Goldendale, WA (US)

(72) Inventors: Scott Dickinson, Goldendale, WA (US); Sarah Dickinson, Goldendale, WA (US)

(21) Appl. No.: 18/410,263

(22) Filed: Jan. 11, 2024

(51) Int. Cl. A01D 90/08; A01D 90/10; B60P 1/16; B60P 1/32

(52) U.S. Cl. CPC A01D 90/08; A01D 90/10; B60P 1/162; B60P 1/32

(57) ABSTRACT

A hay transporting trailer assembly includes a trailer that has a gooseneck hitch, a frame and a plurality of wheels rotatably attached to the frame to roll along a support surface. A bed is mounted to angle downwardly on the frame and the bed has a fixed portion and a tiltable portion. A rack is rollably disposed on the bed and the rack is rollable between a home position and a loading position. The rack is positioned on the tiltable portion of the bed when the rack is in the loading position to facilitate hay to be loaded onto the rack. The rack is positioned on the fixed portion of the bed when the rack is in the home position to transport the hay. A tilting unit is disposed on the trailer for urging the tiltable portion of the bed between the deployed position and the stored position.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to trailer devices and more particularly pertains to a new trailer device for loading and transporting hay. The device includes a trailer with a downwardly angled bed which has a fixed portion and a tiltable portion. The device includes a tilting unit for urging the tiltable portion between a stored position and a deployed position. The device includes a rack that is rollable along the bed and a winch for rolling the rack along the bed.

### (2) Description of Related Art Including Information Disclosed Under 37 CFR 1.97 and 1.98

The prior art relates to trailer devices including a plurality of hay loading devices that each includes a trailer, a series of articulating arms and a grappling unit disposed on the articulating arms for loading hay bales onto the trailer. In no instance does the prior art discloses a trailer that has downwardly angled bed which has a fixed portion and a tiltable portion, a rack rollably disposed on the downwardly angled bed and a tilting unit for tilting the tiltable portion between a deployed position and a stored position.

### (h) BRIEF SUMMARY OF THE INVENTION

An embodiment of the disclosure meets the needs presented above by generally comprising a trailer that has a gooseneck hitch, a frame and a plurality of wheels rotatably attached to the frame to roll along a support surface. A bed is mounted to angle downwardly on the frame and the bed has a fixed portion and a tiltable portion. A rack is rollably disposed on the bed and the rack is rollable between a home position and a loading position. The rack is positioned on the tiltable portion of the bed when the rack is in the loading position to facilitate hay to be loaded onto the rack. The rack is positioned on the fixed portion of the bed when the rack is in the home position to transport the hay. A tilting unit is disposed on the trailer for urging the tiltable portion of the bed between the deployed position and the stored position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side view of a hay transporting trailer assembly according to an embodiment of the disclosure.

FIG. 2 is a front view of an embodiment of the disclosure.

FIG. 3 is a back view of an embodiment of the disclosure.

FIG. 4 is a top view of an embodiment of the disclosure.

FIG. 5 is a side in-use view of an embodiment of the disclosure showing a tiltable portion of a bed in a deployed position and showing a pair of push off feet in an extended position.

### (j) DETAILED DESCRIPTION OF THE INVENTION

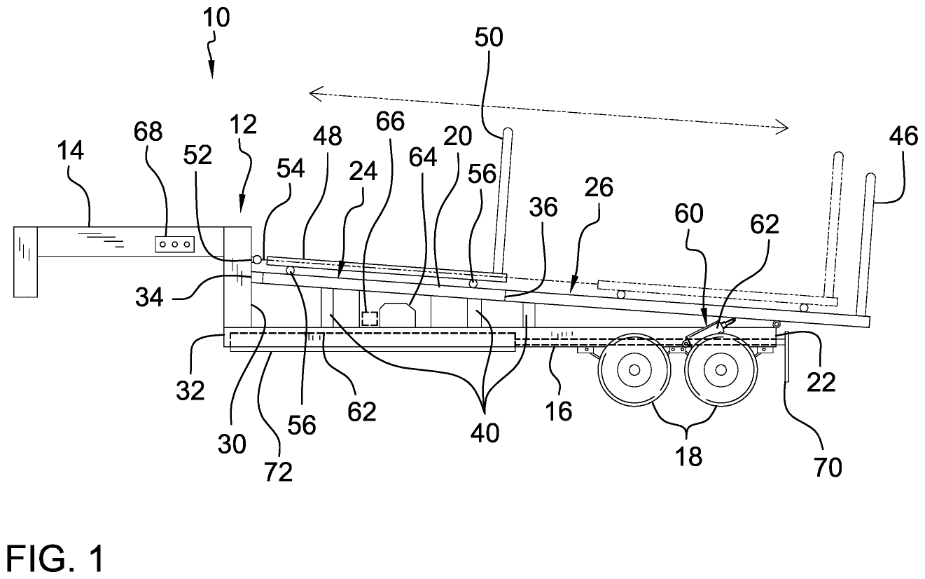

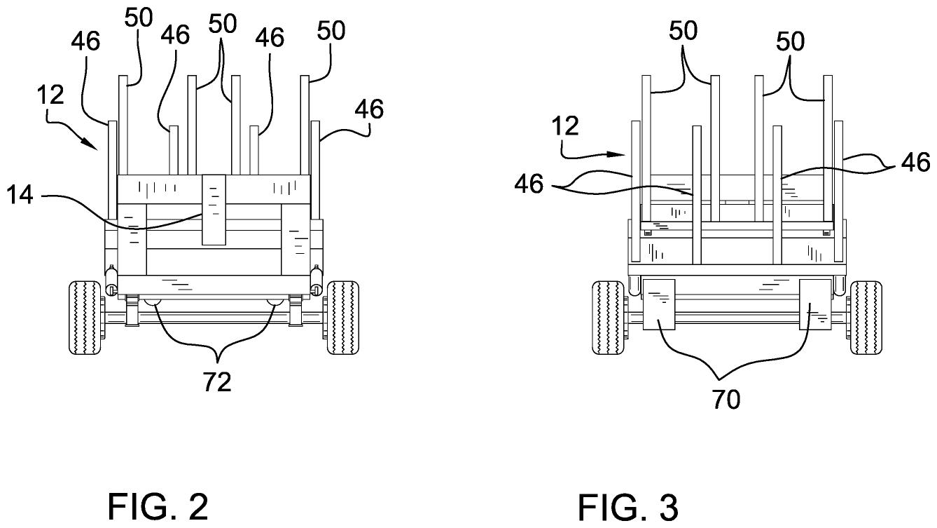

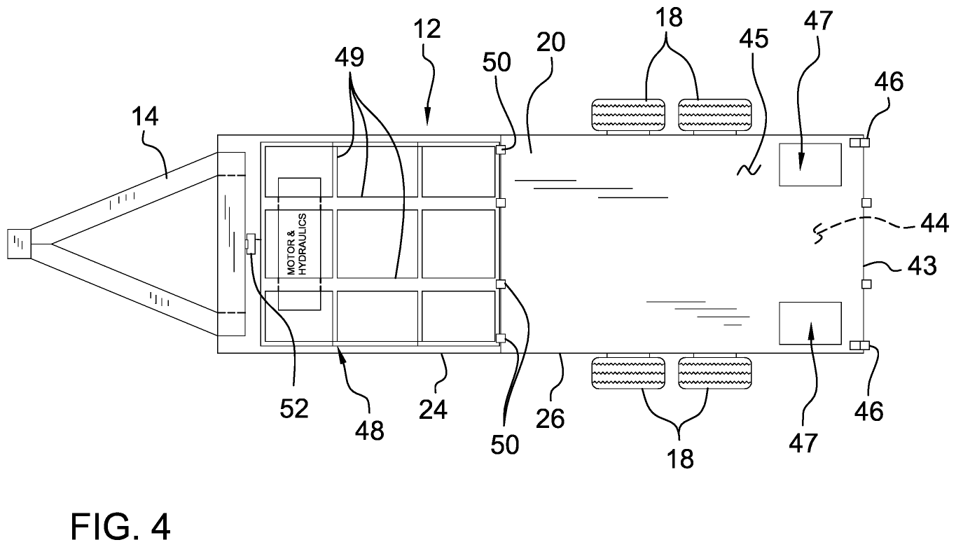

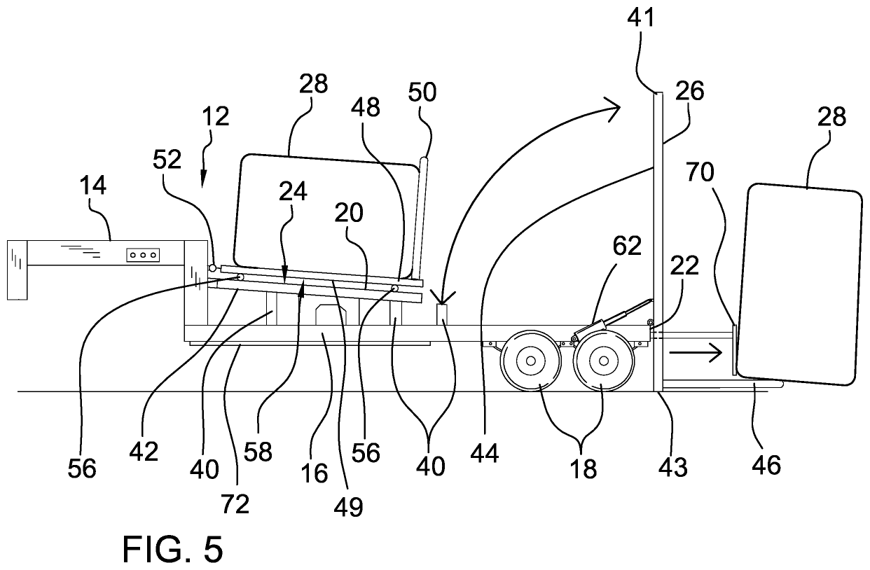

With reference now to the drawings, and in particular to FIGS. 1 through 5 thereof, a new trailer device embodying the principles and concepts of an embodiment of the disclosure and generally designated by the reference numeral 10 will be described.

As is best illustrated in FIGS. 1 through 5, the hay transporting trailer assembly generally comprises a trailer 12 that has a gooseneck hitch 14, a frame 16 and a plurality of wheels 18 rotatably attached to the frame 16 to roll along a support surface. The trailer 12 may be a twin axle trailer that has a maximum load capacity of 6500.00 kg. The trailer 12 has a bed 20 that is mounted on the frame 16 and the bed 20 is oriented to angle downwardly toward a rear end 22 of the frame 16. The bed 20 has a fixed portion 24 that is attached to the frame 16 and the bed 20 has a tiltable portion 26 that is tiltably mounted to the frame 16. The tiltable portion 26 is positionable in a deployed position having the tiltable portion 26 angled to extend downwardly to the ground. In this way the tiltable portion 26 facilitates hay 28 to be loaded onto the tiltable portion 26 with a tractor or other type of farm equipment. Conversely, the tiltable portion 26 is positionable in a stored position having the tiltable portion 26 lying flat on the frame 16 to transport the hay 28. The hay 28 may comprise rectangular hay bales that are stacked into a cube that is too large to be manipulated by an individual.

The gooseneck hitch 14 has a vertical portion 30 extending upwardly from the frame 16 at a point located adjacent to a front end 32 of the frame 16. The fixed portion 24 of the bed 20 has a front end 34 and a back end 36 and the front end 34 is attached to and extends rearwardly from the vertical portion 30 of the gooseneck hitch 14. The trailer 12 has a plurality of uprights 40 each extending between the frame 16 and a bottom surface 42 of the fixed portion 24 of the bed 20. The plurality of uprights 40 decreases in height between the front end 34 and the back end 36 of the fixed portion 24 such that the fixed portion 24 angles downwardly between the front end 34 and the back end 36.

The tiltable portion 26 has a forward end 41, a rear end 43, a lower surface 44 and an upper surface 45; the lower surface 44 is hingedly coupled to the frame 16 at a point located adjacent to the rear end 22 of the frame 16. The forward end 41 is aligned with the back end 36 of the fixed portion 24 when the tiltable portion 26 is in the stored position having the lower surface 44 being oriented coplanar with the bottom surface 42 of the fixed portion 24. A respective one of the uprights 40 is aligned with the tiltable portion 26 such that the lower surface 44 of the tiltable portion 26 rests on the respective upright 40 when the tiltable portion 26 is in the stored position.

The tiltable portion 26 extends beyond the rear end 22 of the frame 16 having the rear end 43 of the tiltable portion 26 being spaced from the rear end 22 of the frame 16. The forward end 41 of the tiltable portion 26 is spaced upwardly from the back end 36 of the fixed portion 24 having the rear end 43 of the tiltable portion 26 abutting the ground when the tiltable portion 26 is in the deployed position. A first set of hay forks 46 is attached to and extends upwardly from the tiltable portion 26 of the bed 20. The first set of hay forks 46 is positioned adjacent to the rear end 43 of the tiltable portion 26. The tiltable portion 26 has a pair of holes 47 which each extends through the upper surface 45 and the lower surface 44 of the tiltable portion 26 and each of the holes 47 is spaced from the rear end 43 of the tiltable portion 26 and the pair of holes 47 are laterally spaced from each other.

A rack 48 is rollably disposed on the bed 20 and the rack 48 is rollable between a home position and a loading position. The rack 48 is positioned on the tiltable portion 26 of the bed 20 when the rack 48 is in the loading position to facilitate hay 28 to be loaded onto the rack 48 when the tiltable portion 26 is in the deployed position. The rack 48 is positioned on the fixed portion 24 of the bed 20 when the rack 48 is in the home position to facilitate the hay 28 on the rack 48 to be transported. The rack 48 is comprised of plurality of intersecting members 49 such that the rack 48 has a frame-like structure. A second set of hay forks 50 is attached to and extends upwardly from the rack 48 and the second set of hay forks 50 is positioned adjacent to a back end 51 of the rack 48. The first hay forks 46 are spaced apart from each other and the second hay forks 50 are spaced apart from each other to inhibit the hay 28 from tipping laterally off of the trailer 12. Furthermore, the trailer 12 and each of the first hay forks 46 and second hay forks 50 have a total combined height of less than approximately 4.2 meters to facilitate the trailer 12 to fit through overhead doors of barns and other storage buildings.

A winch 52 is attached to the vertical portion 30 of the gooseneck hitch 14 and the winch 52 includes a cable 54 that is attached to the forward end 41 of the rack 48. The rack 48 rolls downwardly along the bed 20 when the winch 52 is actuated to rotate in a first direction thereby playing the cable 54 outwardly from the winch 52. Conversely, the rack 48 is drawn upwardly along the bed 20 when the winch 52 is actuated to rotate in a second direction thereby winding the cable 54 around the winch 52. A plurality of rollers 56 is provided and each of the plurality of rollers 56 is rotatably disposed on a bottom surface 58 of respective ones of the plurality of intersecting members 49 of the rack 48. Each of the plurality of rollers 56 rolls along the bed 20 thereby facilitating the rack 48 to travel upwardly and downwardly along the bed 20. The winch 52 may be an electric winch of any conventional design that has a rated maximum load capacity of 6500.00 kg.

A tilting unit 60 is disposed on the trailer 12 and the tilting unit 60 is in communication with the tiltable portion 26 of the bed 20. The tilting unit 60 urges the tiltable portion 26 of the bed 20 between the deployed position and the stored position. The tilting unit 60 comprises a hydraulic cylinder 62 that is coupled between the frame 16 and the tiltable portion 26 of the bed 20. The hydraulic cylinder 62 is actuatable into an elongated condition thereby urging the tiltable portion 26 of the bed 20 into the deployed position. Conversely, the hydraulic cylinder 62 is actuatable into a retracted condition thereby urging the tiltable portion 26 of the bed 20 into the stored position. The hydraulic cylinder 62 engages the tiltable portion 26 at a point that is positioned closer to a hinge point of the tiltable portion 26 than the forward end 41 of the tiltable portion 26.

The tilting unit 60 includes a motor 64 that is attached to the frame 16. The motor 64 may comprise an internal combustion engine with approximately 20.0 horsepower. The tilting unit 60 includes a hydraulic pump 66 that is attached to the frame 16. The hydraulic pump 66 is mechanically coupled to the motor 64 such that the motor 64 drives the hydraulic pump 66 when the motor 64 is running. Furthermore, the hydraulic pump 66 is in fluid communication with the hydraulic cylinder 62 for actuating the hydraulic cylinder 62 between the retracted condition and the extended condition. A control panel 68 is mounted to the trailer 12 and the control panel 68 is in communication with the hydraulic cylinder 62 for actuating the hydraulic cylinder 62 between the extended condition and the retracted condition. Additionally, the control panel 68 is in communication with the winch 52 for actuating the winch 52 to rotate in the first direction and the second direction and the control panel 68 is in communication with the motor 64 to start and stop the motor 64.

A pair of push off feet 70 is each movably integrated into a bottom surface 71 of the frame 16 of the trailer 14 and each of the push off feet 70 is positioned adjacent to the rear end 22 of the frame 16. Each of the pair of push off feet 70 includes an actuator 72 that is mounted to the bottom surface 71 of the frame 16 of the trailer 16 and the actuator associated with each of the push off feet 70 urges each of the push off feet 70 between an extended position and a retracted position. Furthermore, the actuator associated with each of the push off feet comprises a hydraulic cylinder and the actuator 72 associated with each of the push off feet 70 is fluidly coupled to the hydraulic pump 66 to facilitate the actuator 72 associated with each of the push off feet 70 to urge the push off feet 70 between the extended position and the retracted position. Each of the push off feet 70 extends laterally away from the rear end 22 of the frame 16 when the push off feet 70 are in the extended position.

Each of the push off feet 70 extends through a respective one of the pair of holes 47 in the tiltable portion 26 when the tiltable portion 26 is in the deployed position. In this way the push off feet 70 urge the hay off of the first hay forks 46 when the tiltable portion 26 is in the deployed position. Conversely, each of the push off feet 70 is aligned with the rear end 22 of the frame 16 when the push off feet 70 are in the retracted position to facilitate the tiltable portion 26 to be urged into the stored position. The control panel 68 is in communication with the actuator 72 associated with each of the push off feet 70 for extending and retracting the push off feet 70. Additionally, the pair of push off feet 70 can pass through spaces between the plurality of intersecting members 49 of the rack 48 when the rack 48 is in the loading position and the tiltable portion 26 is in the deployed position.

In use, the motor 64 is started to drive the hydraulic pump 66 and winch 52. The winch 52 is actuated to rotate in the first direction to lower the rack 48 into the loading position and the tilting unit 60 is actuated to urge the tiltable portion 26 of the trailer 12 into the deployed position. The hay 28 is loaded onto the rack 48 and the tilting unit 60 is actuated to urge the tiltable portion 26 into the stored position. The winch 52 is subsequently actuated to rotate in the second direction to roll the rack 48 into the home position. The tilting unit 60 is actuated to urge the tiltable portion 26 of the trailer 12 into the deployed position and additional hay 28 is loaded onto the tiltable portion 26. The tilting unit 60 is actuated to urge the tiltable portion 26 into the stored position. In this way the hay 28 on the rack 48 and the hay 28 on the tiltable portion 26 can be transported on the trailer 12. Additionally, the rack 48 can store approximately 50.0 bales of hay 28 and the tiltable portion 26 can store approximately 60.0 bales of hay 28, each of which may have dimensions of approximately 40.0 cm×46.0 cm×122.0 cm. Furthermore, the bales of hay 28 can be rolled a door of a building when the door of the building is not tall enough to facilitate the height of the first hay forks 46 and the second hay forks 50.

The tiltable portion 26 is urged in the deployed position and the push off feet 70 are actuated to push the hay 28 off of the first hay forks 46. The push off feet 70 are actuated into the retracted position and the tiltable portion 46 is urged into the deployed position. The winch 52 is actuated to rotate in the first direction to roll the rack 48 into the loading position to transport the hay 28 on the rack 48 onto the tiltable portion 26. The tiltable portion 26 is urged into the deployed position and the push off feet 70 are actuated into the extended position to push the hay 28 off of the first hay forks 46 and the second hay forks 50. In this way the hay 28 is unloaded from the trailer 12 when the hay 28 has been transported to a desired destination.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hay transporting trailer assembly having a motorized sled and a tiltable bed, said assembly comprising:
a trailer having a gooseneck hitch, a frame and a plurality of wheels rotatably attached to said frame wherein said plurality of wheels is configured to roll along a support surface, said trailer having a bed being mounted on said frame, said bed being oriented to angle downwardly toward a rear end of said frame, said bed having a fixed portion being attached to said frame, said bed having a tiltable portion being tiltably mounted to said frame, said tiltable portion being positionable in a deployed position having said tiltable portion being angled to extend downwardly to the ground wherein said tiltable portion is configured to facilitate hay to be loaded onto said tiltable portion, said tiltable portion being positionable in a stored position having said tiltable portion lying flat on said frame wherein said tiltable portion is configured to transport the hay;
a rack being rollably disposed on said bed, said rack being rollable between a home position and a loading position, said rack being positioned on said tiltable portion of said bed when said rack is in said loading position wherein said rack is configured to facilitate hay to be loaded or unloaded onto said rack when said tiltable portion is in said deployed position, said rack being positioned on said fixed portion of said bed when said rack is in said home position wherein said rack is configured to facilitate the hay on said rack to be transported; and
a tilting unit being disposed on said trailer, said tilting unit being in communication with said tiltable portion of said bed, said tilting unit urging said tiltable portion of said bed between said deployed position and said stored position.

2. The assembly according to claim 1, wherein:
said gooseneck hitch has a vertical portion extending upwardly from said frame at a point located adjacent to a front end of said frame;
said fixed portion of said bed having a front end and a back end, said front end being attached to and extending rearwardly from said vertical portion of said gooseneck hitch; and
said trailer has a plurality of uprights each extending between said frame and a bottom surface of said fixed portion of said bed, said plurality of uprights decreasing in height between said front end and said back end of said fixed portion such that said fixed portion angles downwardly between said front end and said back end.

3. The assembly according to claim 2, wherein:
said tiltable portion has a forward end, a rear end and a lower surface, said lower surface being hingedly coupled to said frame at a point located adjacent to said rear end of said frame;
said forward end is aligned with said back end of said fixed portion when said tiltable portion is in said stored position having said lower surface being oriented coplanar with said bottom surface of said fixed portion;
a respective one of said uprights is aligned with said tiltable portion such that said lower surface of said tiltable portion rests on said respective upright when said tiltable portion is in said stored position;
said tiltable portion extends beyond said rear end of said frame having said rear end of said tiltable portion being spaced from said rear end of said frame; and
said forward end of said tiltable portion is spaced upwardly from said back end of said fixed portion having said rear end of said tiltable portion abutting the ground when said tiltable portion is in said deployed position.

4. The assembly according to claim 1, further comprising a first set of hay forks being attached to and extending upwardly from said tiltable portion of said bed, said first set of hay forks being positioned adjacent to a rear end of said tiltable portion.

5. The assembly according to claim 4, further comprising a second set of hay forks being attached to and extending upwardly from said rack, said second set of hay forks being positioned adjacent to a back end of said rack.

6. The assembly according to claim 1, wherein:
said gooseneck hitch has a vertical portion extending upwardly from said frame at a point located adjacent to a front end of said frame; and
said assembly includes a winch being attached to said vertical portion of said gooseneck hitch, said winch including a cable being attached to a forward end of said rack, said rack rolling downwardly along said bed when said winch is actuated to rotate in a first direction thereby playing said cable outwardly from said winch, said rack being drawn upwardly along said bed when said winch is actuated to rotate in a second direction thereby winding said cable around said winch.

7. The assembly according to claim 1, further comprising a plurality of rollers, each of said rollers being rotatably disposed on a bottom surface of said rack, each of said plurality of rollers rolling along said bed thereby facilitating said rack to travel upwardly and downwardly along said bed.

8. The assembly according to claim 1, wherein said tilting unit comprises:
a hydraulic cylinder being coupled between said frame and said tiltable portion of said bed, said hydraulic cylinder being actuatable into an elongated condition thereby urging said tiltable portion of said bed into said deployed position, said hydraulic cylinder being actuatable into a retracted condition thereby urging said tiltable portion of said bed into said stored position, said hydraulic cylinder engaging said tiltable portion at a point being positioned closer to a hinge point of said tiltable portion than a forward end of said tiltable portion;
a motor being attached to said frame; and
a hydraulic pump being attached to said frame, said hydraulic pump being mechanically coupled to said motor such that said motor drives said hydraulic pump when said motor is running, said hydraulic pump being in fluid communication with said hydraulic cylinder for actuating said hydraulic cylinder between said retracted condition and said extended condition.

9. The assembly according to claim 8, wherein:
said assembly includes a pair of push off feet being movably attached to said trailer;
each of said pair of push off feet is actuatable in a deployed condition having each of said pair of push off feet extending rearwardly beyond said trailer when said tiltable portion of said bed is in said deployed position wherein said pair of push off feet is configured to push the hay off of said tiltable portion;
said pair of push off feet is actuatable into a stored condition having said pair of push off feet being positioned beneath said trailer;
each of said pair of push off feet includes an actuator being attached to said trailer; and
said actuator of each of said push off feet is in communication with hydraulic pump for extending or retracting said actuator of each of said pair of push off feet thereby actuating said pair of push off feet between said deployed condition and said stored condition.

10. A hay transporting trailer assembly having a motorized sled and a tiltable bed, said assembly comprising:
a trailer having a gooseneck hitch, a frame and a plurality of wheels rotatably attached to said frame wherein said plurality of wheels is configured to roll along a support surface, said trailer having a bed being mounted on said frame, said bed being oriented to angle downwardly toward a rear end of said frame, said bed having a fixed portion being attached to said frame, said bed having a tiltable portion being tiltably mounted to said frame, said tiltable portion being positionable in a deployed position having said tiltable portion being angled to extend downwardly to the ground wherein said tiltable portion is configured to facilitate hay to be loaded onto said tiltable portion, said tiltable portion being positionable in a stored position having said tiltable portion lying flat on said frame wherein said tiltable portion is configured to transport the hay, said gooseneck hitch having a vertical portion extending upwardly from said frame at a point located adjacent to a front end of said frame, said fixed portion of said bed having a front end and a back end, said front end being attached to and extending rearwardly from said vertical portion of said gooseneck hitch, said trailer having a plurality of uprights each extending between said frame and a bottom surface of said fixed portion of said bed, said plurality of uprights decreasing in height between said front end and said back end of said fixed portion such that said fixed portion angles downwardly between said front end and said back end, said tiltable portion having a forward end, a rear end and a lower surface, said lower surface being hingedly coupled to said frame at a point located adjacent to said rear end of said frame, said forward end being aligned with said back end of said fixed portion when said tiltable portion is in said stored position having said lower surface being oriented coplanar with said bottom surface of said fixed portion, a respective one of said uprights being aligned with said tiltable portion such that said lower surface of said tiltable portion rests on said respective upright when said tiltable portion is in said stored position, said tiltable portion extending beyond said rear end of said frame having said rear end of said tiltable portion being spaced from said rear end of said frame, said forward end of said tiltable portion being spaced upwardly from said back end of said fixed portion having said rear end of said tiltable portion abutting the ground when said tiltable portion is in said deployed position;
a first set of hay forks being attached to and extending upwardly from said tiltable portion of said bed, said first set of hay forks being positioned adjacent to said rear end of said tiltable portion;
a rack being rollably disposed on said bed, said rack being rollable between a home position and a loading position, said rack being positioned on said tiltable portion of said bed when said rack is in said loading position wherein said rack is configured to facilitate hay to be loaded or unloaded onto said rack when said tiltable portion is in said deployed position, said rack being positioned on said fixed portion of said bed when said rack is in said home position wherein said rack is configured to facilitate the hay on said rack to be transported;
a second set of hay forks being attached to and extending upwardly from said rack, said second set of hay forks being positioned adjacent to a back end of said rack;
a winch being attached to said vertical portion of said gooseneck hitch, said winch including a cable being attached to a forward end of said rack, said rack rolling downwardly along said bed when said winch is actuated to rotate in a first direction thereby playing said cable outwardly from said winch, said rack being drawn upwardly along said bed when said winch is actuated to rotate in a second direction thereby winding said cable around said winch;
a plurality of rollers, each of said rollers being rotatably disposed on a bottom surface of said rack, each of said plurality of rollers rolling along said bed thereby facilitating said rack to travel upwardly and downwardly along said bed;
a tilting unit being disposed on said trailer, said tilting unit being in communication with said tiltable portion of said bed, said tilting unit urging said tiltable portion of said bed between said deployed position and said stored position, said tilting unit comprising:
a hydraulic cylinder being coupled between said frame and said tiltable portion of said bed, said hydraulic cylinder being actuatable into an elongated condition thereby urging said tiltable portion of said bed into said deployed position, said hydraulic cylinder being actuatable into a retracted condition thereby urging said tiltable portion of said bed into said stored position, said hydraulic cylinder engaging said tiltable portion at a point being positioned closer to a hinge point of said tiltable portion than said forward end of said tiltable portion;
a motor being attached to said frame; and
a hydraulic pump being attached to said frame, said hydraulic pump being mechanically coupled to said motor such that said motor drives said hydraulic pump when said motor is running, said hydraulic pump being in fluid communication with said hydraulic cylinder for actuating said hydraulic cylinder between said retracted condition and said extended condition; and
a pair of push off feet being movably attached to said trailer, each of said pair of push off feet being actuatable in a deployed condition having each of said pair of push off feet extending rearwardly beyond said trailer when said tiltable portion of said bed is in said deployed position wherein said pair of push off feet is configured to push the hay off of said tiltable portion, said pair of push off feet being actuatable into a stored condition having said pair of push off feet being positioned beneath said trailer, each of said pair of push off feet including an actuator being attached to said trailer, said actuator of each of said push off feet being in communication with hydraulic pump for extending or retracting said actuator of each of said pair of push off feet thereby actuating said pair of push off feet between said deployed condition and said stored condition.
